(19) United States
(12) Patent Application Publication
(10) Pub. No.: US 2026/0268743 A1
(43) Pub. Date: Sep. 10, 2026

(54) PULL-TAB GAMING

(71) Applicants: TECHNIK MFG., INC., Columbus, NE (US); USA PULLTABS, LLC, La Crosse, WI (US)

(72) Inventors: Douglas J. OBAL, Columbus, NE (US); Anna V. SCHMITZ, Saint Paul, MN (US); Andrew J. SCHMITZ, Saint Paul, MN (US)

(73) Assignees: TECHNIK MFG., INC., Columbus, NE (US); USA PULLTABS, LLC, La Crosse, WI (US)

(21) Appl. No.: 19/317,039

(22) Filed: Sep. 2, 2025

Related U.S. Application Data
(63) Continuation-in-part of application No. 19/074,050, filed on Mar. 7, 2025.

(51) Int. Cl. G07F 17/32; G07F 17/42

(52) U.S. Cl. CPC G07F 17/329; G07F 17/42

(57) ABSTRACT

A pull-tab-ticket vending machine is configured to automatically redeem a prize-winning pull-tab ticket in the form of a cash prize and/or purchase credits, as selected by the player. In some examples, the pull-tab-ticket vending machine includes an integrated voucher printer paired with a separate prize-redemption device, whereby, in response to the player selecting a “cash” option, the printer generates and prints a paper voucher bearing a scannable code that, when scanned by the prize-redemption device, causes the prize-redemption device to dispense the user's cash prize.

### PRIORITY CLAIM

This utility patent application is a continuation-in-part of U.S. patent application Ser. No. 19/074,050, filed Mar. 7, 2025, and titled “PULLTAB GAMING,” the entire contents of which are incorporated herein by reference.

### TECHNICAL FIELD

The present technology is generally related to pull-tabs (and other games of chance), and electronic vending machines thereof.

### BACKGROUND

“Pull-tabs” is a popular game of chance played in bars, pubs, breweries, restaurants, and other hosting establishments throughout the world. Known also as “pop-opens,” “break-opens,” and “pickle tickets,” pull-tab games involve a set of small paper-based tickets available for individual purchase by patrons of the hosting establishment. Typically, a designated vendor (or “game operator”), staffing a booth within the hosting establishment, manually sells pull-tab tickets to players of the game. Bartenders or other employees of the hosting establishment often manage the pull-tab games as well.

Typical pull-tab tickets include two or more paper-based (e.g., cardboard) layers coupled together: a bottom layer, featuring one or more randomized game entries; and a perforated top layer adhered overtop of the bottom layer to (initially) conceal the game entries. After purchase, the player rips or tears open a set of perforated strips (or “tabs”) on the top layer of the pull-tab ticket to reveal the game entry concealed underneath. Upon revealing a prize-winning game entry, the player typically returns the opened ticket to the game operator in exchange for a cash prize. Frequently, players use some or all of their cash prize to purchase additional pull-tab tickets to continue playing the game for even greater potential prizes.

### SUMMARY OF THE DISCLOSURE

The techniques of this disclosure generally relate to systems, devices, and methods for automating certain aspects of a pull-tab game—specifically, techniques for providing players with the option to redeem their winning pull-tab tickets for cash prizes and/or for credits toward the purchase of additional pull-tab tickets. As a representative (non-limiting) example, a pull-tab-gaming system includes a pull-tab-ticket vending machine, and a prize-redemption device paired with the vending machine, whereby the vending machine is configured to validate a prize-winning pull-tab ticket, and then redeem the ticket's prize according to a format desired and selected by the player—such formats including: credit(s) toward the purchase of additional pull-tab ticket(s) from the vending machine; and a paper voucher featuring a printed code to cause the prize-redemption device to dispense a cash prize. In some (but not all) such examples, the player is able to “split” their winning pull-tab ticket's prize between a desired number of purchase credits and amount of cash (having a collective value equal to the ticket's prize amount), or equivalently, a certain ratio of credits-to-cash applied to the ticket's prize amount.

In some examples, a pull-tab-ticket vending machine includes: a pull-tab-ticket collector-and-scanner; a voucher printer communicatively paired with a prize-redemption device; and processing circuitry communicatively coupled to both the pull-tab-ticket collector-and-scanner and the voucher printer, wherein the processing circuitry is configured to: receive, from the pull-tab-ticket collector-and-scanner, a prize-verification code encoded by a first scannable code printed on a pull-tab ticket dispensed from the vending machine; determine, based on a set of game data stored in a memory of the vending machine, that the pull-tab ticket is a prize-winning ticket and has not already been redeemed; determine, based on the set of game data, a prize denomination associated with the prize-winning ticket; in response to receiving a first user input, internally activate one or more credits for purchasing additional pull-tab tickets from the vending machine; and in response to receiving a second user input, cause the voucher printer to print a paper voucher bearing a second scannable code that, when scanned by the prize-redemption device, causes the prize-redemption device to dispense a cash prize, wherein a collective value of the credits and the cash prize is equal to the prize denomination for the prize-winning ticket.

In some examples, a method includes: receiving, by processing circuitry of a pull-tab-ticket vending machine from a pull-tab-ticket collector-and-scanner of the vending machine, a prize-verification code encoded by a first scannable code printed on a pull-tab ticket dispensed from the vending machine; determining, by the processing circuitry based on a set of game data stored in a memory of the vending machine, that the pull-tab ticket is a prize-winning ticket and has not already been redeemed; determining, by the processing circuitry based on the set of game data, a prize denomination associated with the prize-winning ticket; in response to receiving a first user input, internally activating, by the processing circuitry, one or more credits for purchasing additional pull-tab tickets from the vending machine; and, in response to receiving a second user input, causing, by the processing circuitry, a voucher printer of the vending machine to print a paper voucher bearing a second scannable code that, when scanned by a prize-redemption device, causes the prize-redemption device to dispense a cash prize, wherein a collective value of the credits and the cash prize is equal to the prize denomination for the prize-winning ticket.

In some examples, a non-transitory computer-readable medium includes instructions that, when executed by a processor of a pull-tab-ticket vending machine, cause the processor to: receive, from a pull-tab-ticket collector-and-scanner of the vending machine, a prize-verification code encoded by a first scannable code printed on a pull-tab ticket dispensed from the vending machine; determine, based on a set of game data stored in a memory of the vending machine, that the pull-tab ticket is a prize-winning ticket and has not already been redeemed; determine, based on the set of game data, a prize denomination associated with the prize-winning ticket; in response to receiving a first user input, internally activate one or more credits for purchasing additional pull-tab tickets from the vending machine; and, in response to receiving a second user input, cause a voucher printer of the vending machine to print a paper voucher bearing a second scannable code that, when scanned by a prize-redemption device, causes the prize-redemption device to dispense a cash prize, wherein a collective value of the credits and the cash prize is equal to the prize denomination for the prize-winning ticket.

The details of one or more aspects of the disclosure are set forth in the accompanying drawings and the description below. Other features, objects, and advantages of the techniques described in this disclosure will be apparent from the description and the drawings, and from the claims.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a conceptual diagram of an example pull-tab-gaming system, including a pull-tab-ticket vending machine and a prize-redemption device.

FIG. 2 shows an example of a prize-winning pull-tab ticket of the pull-tab-gaming system of FIG. 1.

FIG. 3A is an oblique view of an example of the pull-tab-ticket vending machine of FIG. 1.

FIG. 3B is a front view of the pull-tab-ticket vending machine of FIG. 3A.

FIG. 3C shows a front panel of the pull-tab-ticket vending machine of FIGS. 3A and 3B.

FIG. 3D shows some internal components of the pull-tab-ticket vending machine of FIGS. 3A-3D.

FIG. 4 is a conceptual block diagram of an example computing architecture of the vending machine of FIGS. 1 and 3A-3D.

FIG. 5 is an oblique view of an example pull-tab-ticket collector-and-scanner of the vending machine of FIGS. 1 and 3A-3D.

FIG. 6 is an oblique view of an example cash-voucher printer of the vending machine of FIGS. 1 and 3A-3D.

FIG. 7 is a front view of an example of the prize-redemption device of FIG. 1.

FIG. 8 is a flowchart of an example method of operation of the pull-tab-ticket vending machine of FIG. 1.

FIG. 9 is a flowchart of another example method of operation of the pull-tab-ticket vending machine of FIG. 1.

FIG. 10 is a flowchart of another example method of operation of the pull-tab-ticket vending machine of FIG. 1.

While examples of this disclosure are amenable to various modifications and alternative forms, specifics thereof shown by way of example in the drawings will be described in detail. It should be understood, however, that the intention is not to limit the disclosure to the particular examples described.

### DETAILED DESCRIPTION

The present disclosure describes various examples of systems, devices, and methods for automating certain aspects of a pull-tab game—specifically, techniques for providing players with the option to redeem their winning pull-tab tickets for cash prizes and/or for credits toward the purchase of additional pull-tab tickets.

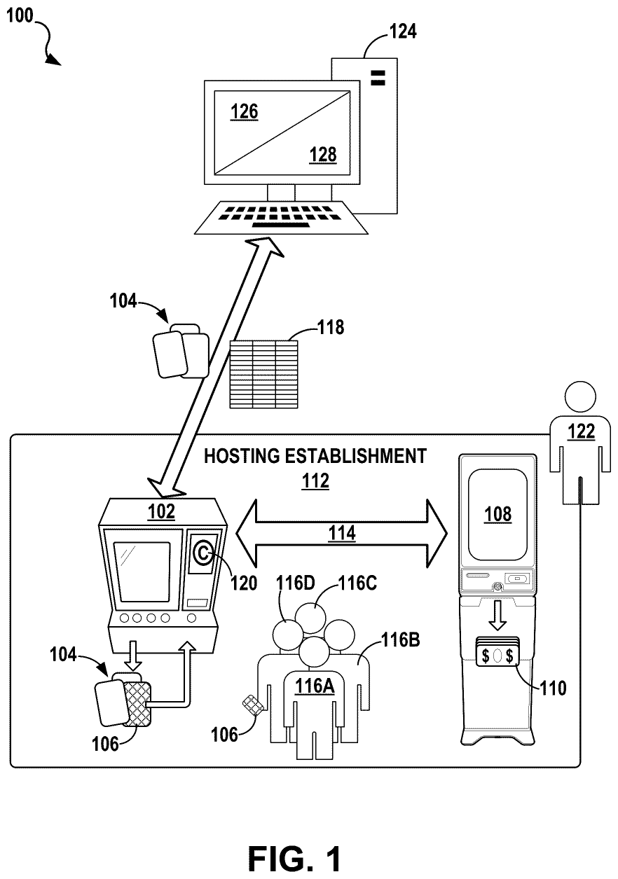

FIG. 1 is a high-level conceptual diagram of an example system 100 for providing and running a pull-tab game. The system 100 includes at least: (1) a vending machine 102 configured to dispense a set of pull-tab tickets 104, including one or more prize-winning tickets 106; and (2) a prize-redemption device 108 configured to dispense cash prizes 110 corresponding to the prize-winning tickets 106. The vending machine 102 and the prize-redemption device 108 are preferably placed within close proximity of each other, such as located within a common hosting establishment 112. As detailed further below, the vending machine 102 and the prize-redemption device 108 are interactively “paired” (arrow 114) to perform certain functions.

Additional details of example components, features, aspects, functions, and configurations for the system 100 are shown and described in the following co-pending U.S. patent applications, the entire contents of which are hereby incorporated by reference into the present disclosure: (1) Utility application Ser. No. 19/074,050 (“PULLTAB GAMING”) filed Mar. 7, 2025; (2) Design App. No. Ser. No. 29/992,419 (“PULLTAB-CARD COLLECTOR-AND-SCANNER”) filed Mar. 7, 2025; (3) Utility application Ser. No. 19/043,244 (“PULLTAB GAMING”) filed on Jan. 31, 2025; (4) Utility application Ser. No. 18/774,631 (“PULLTAB GAMING”) filed on Jul. 16, 2024; (5) U.S. Design Patent Application No. Ser. No. 29/934,702 (“PULLTAB CARDS”) filed on Mar. 27, 2024; and (6) Utility application Ser. No. 18/605,766 (“PULLTAB GAMING”) filed on Mar. 14, 2024.

During operation of an example pull-tab game run by system 100, one or more players 116A-116D purchase pull-tab tickets 104 from the vending machine 102, and then tear open the paper tabs on the tickets 104 to reveal whether each ticket 104 is a prize-winning ticket 106. A player 116D who purchases a prize-winning ticket 106 can insert the ticket 106 back into the vending machine 102, whereby the vending machine 102 automatically performs a verification process. During the verification process, the vending machine 102 consults a set of game data 118 to confirm that: (1) the ticket 106 is indeed a prize-winning ticket; and (2) the ticket 106 has not already been redeemed. In some examples, a site manager 122 (or a game manager facilitating pull-tab games at multiple different establishments 112 simultaneously) manually uploads the game data 118 into a local memory of the vending machine 102, such as via a removable memory device (e.g., USB drive or SD card). In other examples, the site manager 122 or game manager wirelessly retrieves or downloads the game data 118 from a remote computing device 124, such as a server or network initially used to generate and store the game data 118.

Upon successfully completing both steps of the verification process, the vending machine 102 is configured to determine, from the game data 118, a predetermined prize amount (or “prize denomination”) corresponding to the prize-winning ticket 106.

Additionally, in accordance with the techniques of this disclosure, upon successfully completing both steps of the verification process for a prize-winning ticket 106, the vending machine 102 is configured to prompt the winning player 116D to select a desired format in which to redeem the prize associated with their winning ticket 106. Selectable options for the player's prize format include: a cash prize 110 from the prize-redemption device 108; credit(s) 120 toward the purchase of additional pull-tab ticket(s) 104 from the vending machine 102; and, in some examples (but not all examples), a combination of cash 110 and credits 120.

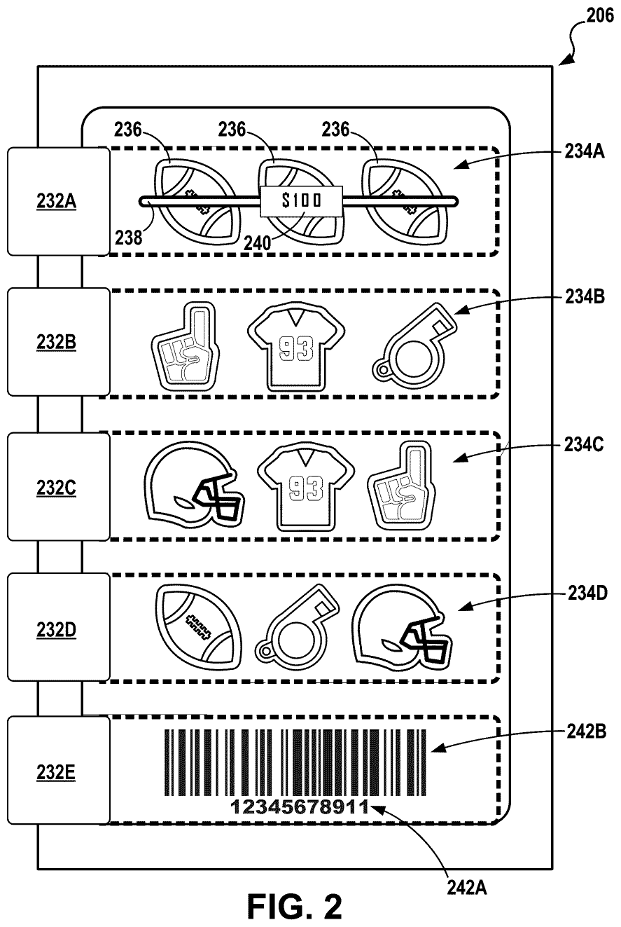

FIG. 2 shows an example implementation (206) of the prize-winning pull-tab ticket 106 of FIG. 1. In the example shown in FIG. 2, the wining player 116D has ripped open all five of the ticket's perforated tabs 232A-232E to reveal the game entries 234A-234D thereunder.

For instance, upon tearing open the first perforated tab 232A, the player 116D discovers that the game entry 234A includes a particular sequence of icons 236 (depicted here as three consecutive football-shaped icons 236), which, under the rules of the corresponding pull-tab game, constitutes a winning game entry 234—thus, the pull-tab ticket 206 is a prize-winning ticket.

When the pull-tab-game generator 124 (FIG. 1) generates each set of pull-tab tickets 104 and the corresponding set of game data 118, the generator 124 automatically identifies all of the winning game entries for the respective pull-tab game, and graphically marks the winning game entries with a horizontal line 238 in order to simplify and expedite the game for the player 116D. Additionally, upon generating a winning game entry 234A, the pull-tab-game generator 124 designates the winning entry 234A (or, in other examples, a different (non-winning) game entry 234B-234D on the same ticket 206) with a numerical prize-amount (or “prize-denomination”) indicator 240.

Concurrently, the pull-tab-game generator 124, upon generating a winning game entry 234A, designates the prize-winning ticket 206 with a unique identifier—a “prize-verification code” 242—thereby enabling automation of a subsequent portion of the pull-tab game in which the player 116D redeems the predetermined prize associated with the winning ticket 206. In the example of FIG. 2, the prize-verification code had been strategically concealed beneath the fifth perforated tab 232E, and includes both a numeric (or alphanumeric) prize-verification code 242A, and a machine-scannable code 242B, such as a barcode, QR code, etc., that digitally encodes the numeric/alphanumeric prize-verification code 242A.

In the example shown in FIG. 2, the numeric prize-verification code 242A and the scannable prize-verification code 242B occupy the space that would otherwise be occupied by a fifth game entry 234(E). But since the ticket 206 is already a prize-winning ticket, any game entries other than the winning game entry 234A are not necessary to be included on the same pull-tab ticket 206.

The alphanumeric prize-verification code 242A is shown in FIG. 2 as an eleven-digit numeric sequence; however, other sequences have also been contemplated, such as a twelve-digit numeric sequence, or a six-or-seven character alphanumeric sequence (as just a few non-limiting examples). In some examples, the prize-verification code 242A is mapped, within the game data 118 (FIG. 1), to a distinct “game serial number” that indicates which pull-tab game the pull-tab ticket 206 belongs to, upon generation of the game data 118 by the pull-tab-game generator 124.

In other examples, the alphanumeric prize-verification code 242A encoded by the scannable code 242B is a fourteen-digit numeric sequence, in which the ticket's corresponding entry within game data 118 is represented by groups of adjacent digits. For instance, the first (i.e., left-most) six digits of the prize-verification code 242A may constitute the “game serial number”; the next (i.e., middle) four digits of the prize-verification code 242A may constitute be the “denomination code” indicating the predetermined prize amount associated with the pull-tab ticket 206; and the last (i.e., right-most) four digits of the prize-verification code 242A may constitute a “winning-ticket ID” used to distinguish between pull-tab tickets 104 from the same gameset that also share the same denomination code. That is, a single set of pull-tab tickets 104 may include multiple winning tickets 106 each having the same prize amount. Within each of these same-game-same-prize ticket subsets, every prize-winning ticket 106 is assigned a different winning-ticket ID (e.g., 0001, 0002, 0003, 0004, . . . ) to identify and track individual prize-winning tickets 106 as they are redeemed, thereby preventing the same prize-winning ticket 106 from being redeemed more than once.

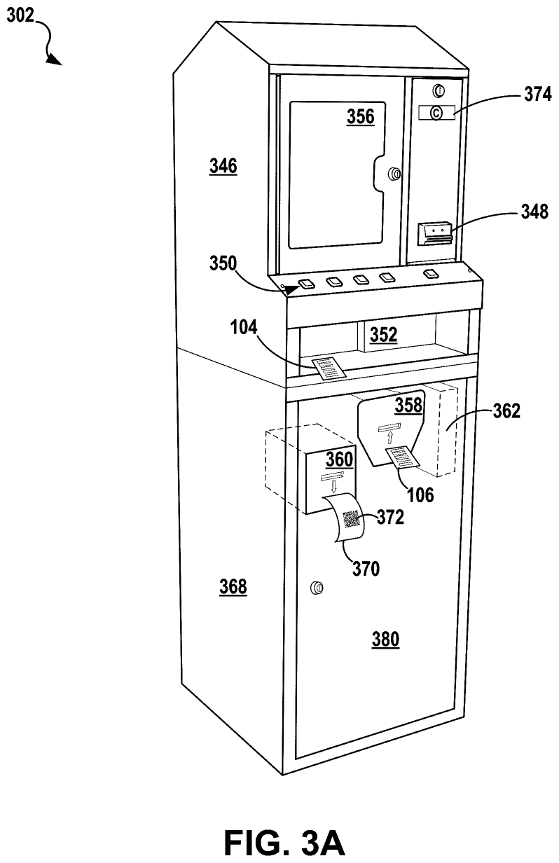

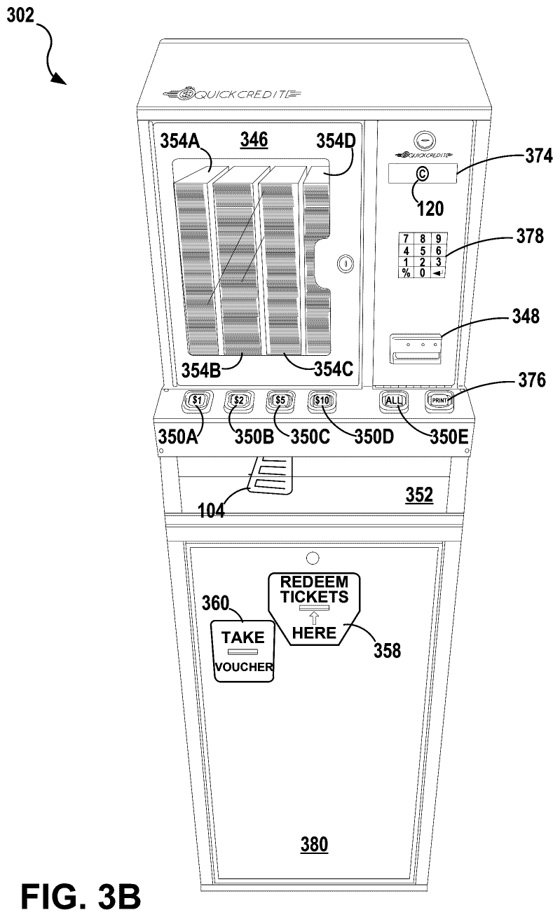

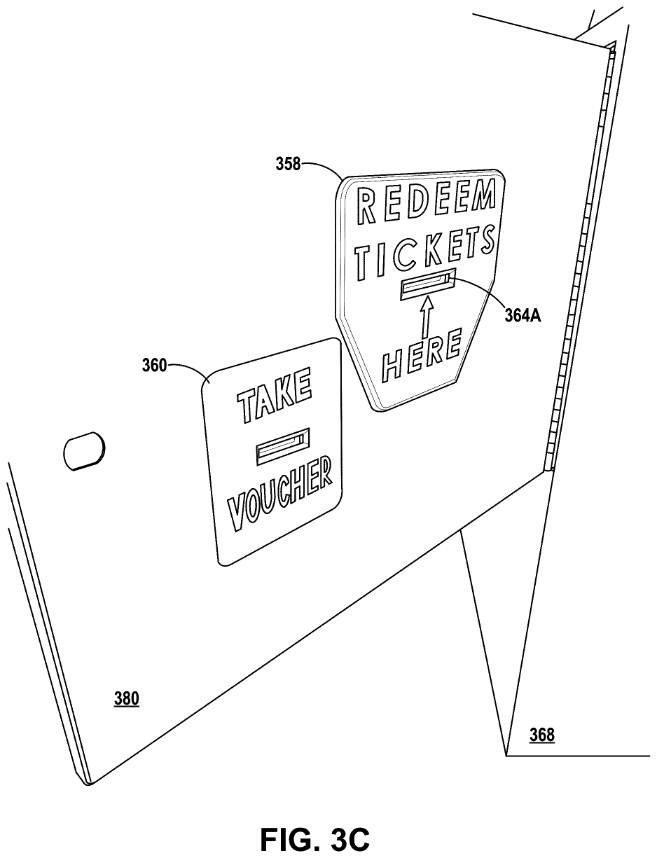

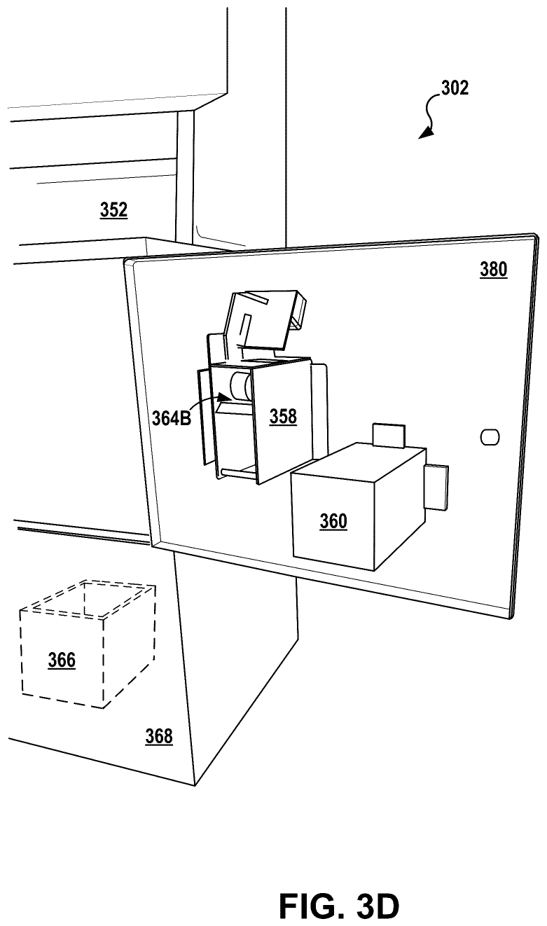

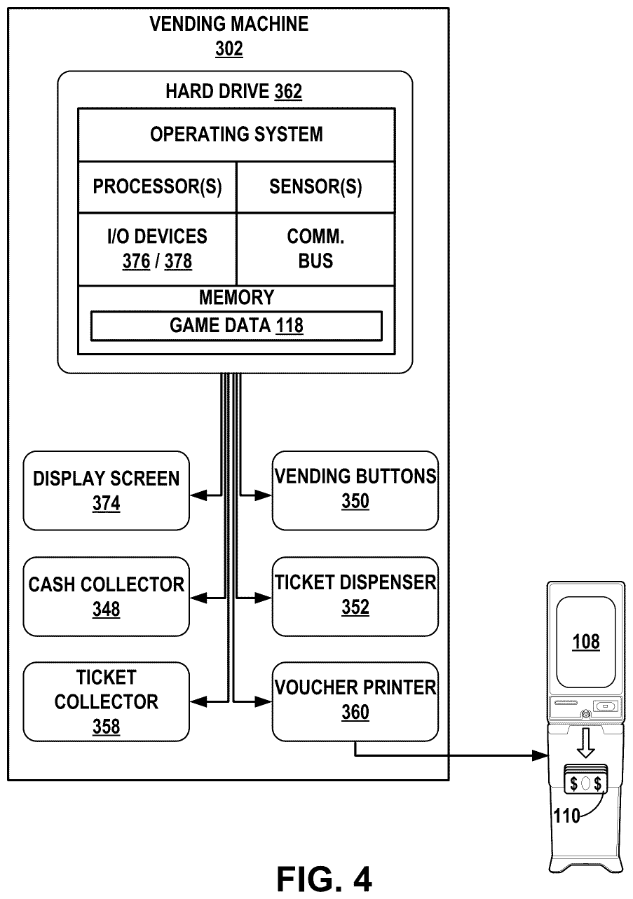

FIGS. 3A-3D show a first non-limiting example implementation (302) of the vending machine 102 of FIG. 1, and FIG. 4 is a conceptual block diagram for the internal computing architecture thereof. The vending machine 302 includes a lockable ticket retainer 346, a cash-deposit slot 348, a plurality of selectable “vending” buttons 350A-350E, and a pull-tab-ticket dispenser 352. In this example (but not all examples), the lockable ticket retainer 346 is configured to house four columns or stacks 354A-354D of pull-tab tickets 104, as viewed through transparent window 356. Each column or stack 354 corresponds to one of four different pull-tab games running simultaneously. For instance, stack 354A includes pull-tab tickets available for $1 each, as indicated by 1^{st} button 350A. Stack 354B includes pull-tab tickets available for $2 each, as indicated by 2^{nd} button 350B. Stack 354C includes pull-tab tickets available for $5 each, as indicated by 3^{rd} button 350C. And stack 354D includes pull-tab tickets available for $10 each, as indicated by 4^{th} button 350D. In other examples, the lockable ticket retainer 346 can retain pull-tab tickets 104 from more, fewer, or different games. For instance, in a different example, columns 354A and 354B could include pull-tab tickets from the same game, in which case buttons 350A and 350B would display the same dollar amount for purchase.

While the vending machine 302 is in its default “Vending” mode, a player 116 initiates a purchase transaction by depositing cash into the cash-deposit slot 348, thereby activating a proportional number of purchase credits 120 within the machine 302. In response to the vending machine 100 receiving cash through cash-deposit slot 348 and activating the purchase credits 120, one or more of the “vending” buttons 350A-350D is configured to illuminate, indicating which stack(s) 354 of pull-tab tickets 104 the player can select from. For instance, if the player 116 deposited $5, then buttons 350A, 350B, and 350C would illuminate, but not button 350D, as the player 116 did not deposit sufficient cash (and thus, does not have enough credits 120) to purchase a $10 pull-tab ticket from stack 354D. In that case, the player 116 can select from any combination of buttons 350A-350C to purchase a number of pull-tab tickets collectively adding up to $5. As a few examples, the player 116 could select the 1^{st} button 350A five times; or, the player 116 could select the 1^{st} button 350A three times and the 2^{nd} button 350B one time; or, the player 116 could select the 3^{rd} button 350C one time.

The vending machine 302 also includes an “ALL” button 350E. By selecting this button, the player 116 indicates to the vending machine 302 that they would like to select “all” of their tickets 104 from a common stack 354. For instance, rather than pressing the 1^{st} button 350A five times in a row, the player could press the “ALL” button 350E, and then press the 1^{st} button 350A; the vending machine 302 will automatically begin grabbing pull-tab tickets 104 drawn from stack 354A, and dispensing each pull-tab ticket 104 outward through the ticket-dispensing area 352, until either (1) the player's cash deposit is spent, or (2) the player 116 aborts the dispensing by pressing a different button 350. Other examples of the vending machine 302 can include additional and/or different types of user-input devices other than pressable buttons 350, such as a digital touchscreen, a joystick, a scroll wheel, or any other suitable mechanism for indicating the player's ticket-stack selection to the vending machine 302.

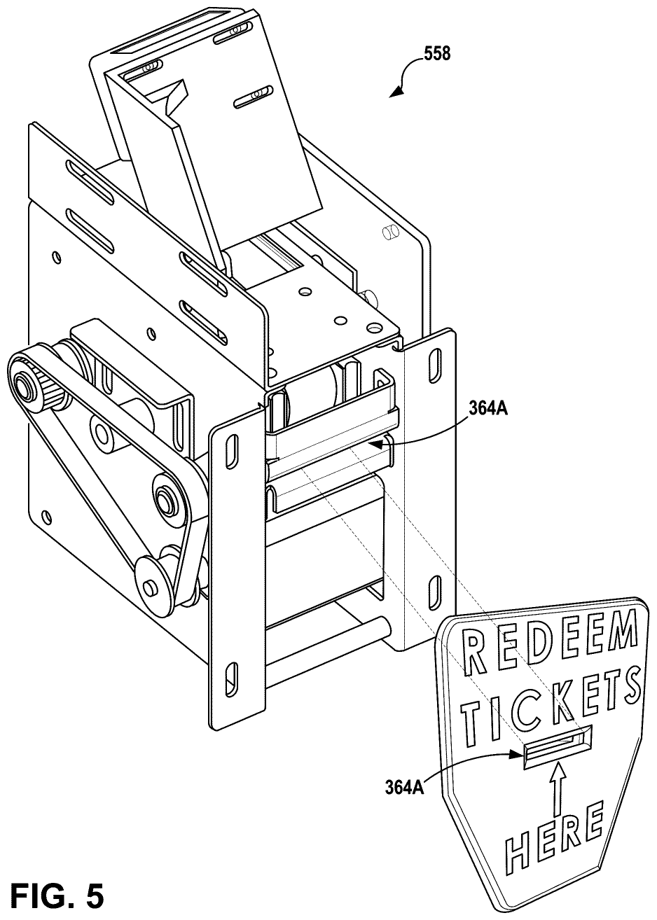

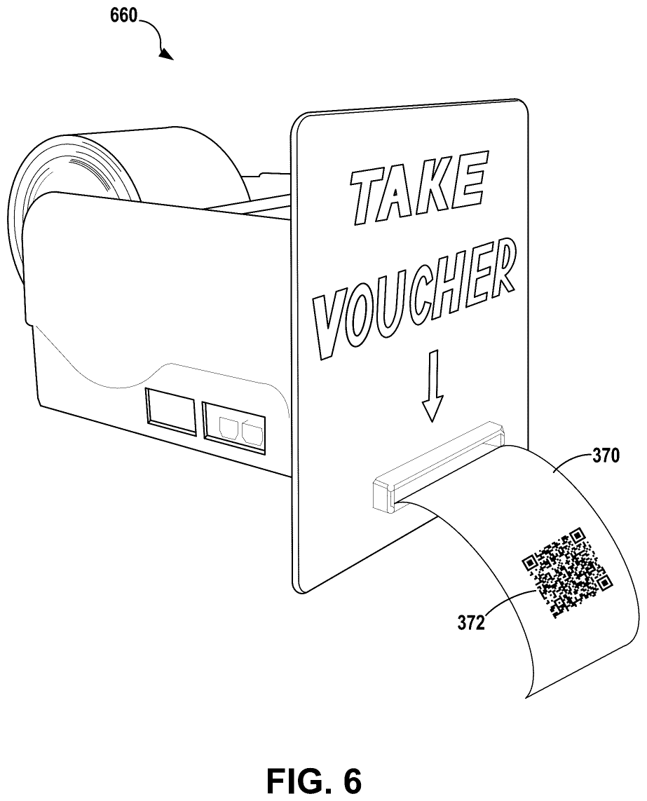

In accordance with the techniques of this disclosure, the vending machine 100 further includes: a custom-built pull-tab-ticket collector-and-scanner 358 (hereinafter, “ticket collector 358”), and a cash-voucher printer 360, both communicatively coupled to the vending machine's central computing device 362 (hereinafter, “hard drive 362”). FIG. 5 shows an example implementation (558) of the ticket collector 358, and FIG. 6 shows an example implementation (660) of the voucher printer 360.

In general, the ticket collector 358 is configured to automatically intake, scan, and securely retain pull-tab tickets that have been purchased and played (i.e., that have had their tabs 232 opened). For instance, a player can insert their pull-tab ticket 104 into the proximal slot 364A, whereby the ticket collector 358 scans the pull-tab ticket 206, attempting to detect a scannable prize-verification code 242B, such as a barcode or Quick-Response (QR) code, printed on the ticket.

If the ticket collector 358 does not detect a scannable prize-verification code 242B printed on the pull-tab ticket 104 before the leading edge of the ticket 104 reaches the distal side of the ticket collector 358, then the ticket collector 358 “rejects” the pull-tab ticket 104 by ejecting the ticket back out through the proximal slot 364A. Similarly, if the ticket collector 358 detects a scannable code 242B on the pull-tab ticket 104, but the vending machine's hard drive 362 fails to verify the code 242 based on the game data 118 stored in memory, then the hard drive 362 transmits an “unverified” signal back to the ticket collector 358 that causes the ticket collector 358 to eject the pull-tab ticket 104 back out through the proximal slot 364A.

Conversely, upon successfully detecting and scanning a scannable code 242B, the ticket collector 358 transmits the prize-verification code 242 to the primary hard drive 362 of the vending machine 302 (or another communicatively-coupled computing device) to verify the code 242, based on the set of game data 118 stored on the hard drive 362. In response to successfully validating the prize-verification code 242, thereby identifying the pull-tab ticket 104 as a prize-winning ticket 106, the vending machine's hard drive 362 automatically executes a series of actions.

First, the hard drive 362 transmits a “verified” signal back to the ticket collector 358, causing the ticket collector 358 to further advance the pull-tab ticket 104 until the ticket is ejected outward through a distal slot 364B of the ticket collector 358. From there, the pull-tab ticket 104 falls into a secure receptacle 366 located fully within the external housing 368 of the vending machine 302, i.e., where the ticket 104 cannot be retrieved by the player.

Second, the vending-machine's hard drive 362 ascertains, based on the game data 118 stored in memory, a prize amount (or “prize denomination”) associated with the prize-winning ticket 106. In some examples, but not all examples, the hard drive 362 is configured to automatically compare the prize-denomination value to a predetermined “maximum-credit” value stored in memory. The maximum-credit value represents a prize denomination above which, for one or more reasons (e.g., laws and regulations, economic feasibility, contractual obligations), the player's prize cannot be awarded as purchase credits 120, and instead must be awarded in the form of cash 110 dispensed by the prize-redemption device 108. Accordingly, if the retrieved prize-denomination value for the prize-winning ticket 106 is greater than the maximum-credit value, the vending machine's hard drive 362 automatically commands the cash-voucher printer 360 to generate and print out a paper voucher 370 bearing a scannable voucher code 372 to receive cash 110 from the prize-redemption device 108.

Conversely, if the retrieved prize-denomination value for the prize-winning ticket 106 is less-than-or-equal-to the maximum-credit value, then the vending machine's hard drive 362 thirdly activates a “Select Prize Format” mode of the vending machine 302, in which the vending machine 302 is configured to receive user input indicating the player's desired prize format: cash 110 and/or credits 120.

In a first example of the “Select Prize Format” mode, the player's prize-format options are limited to a binary selection between “all cash (110)” and “all credits (120).” In this example, the vending machine 302 is configured to temporarily re-purpose two of the existing “vending” buttons 350. For instance, the vending machine may re-purpose and illuminate the 2^{nd} button 350B and the 3^{rd} button 350C. In accordance with a set of written instructions output to the machine's display screen 374, the player can press the 2^{nd} button 350B to select “all cash (110),” or press the 3^{rd} button 350C to select “all credits (120).” By selecting “all cash (110),” the vending machine's hard drive 362 commands the voucher printer 362 to generate and print out a paper voucher 370 bearing a scannable voucher code 372 to receive the full prize denomination in cash 110 from the prize-redemption device 108.

Conversely, by selecting “all credits (120),” the vending machine 302 internally generates a number of purchase credits 120 equivalent to the full prize denomination, and then reverts back to its default “Vending” mode, as described above. For instance, if the prize-winning ticket 106 had a prize denomination of $10, then the hard drive 362 would cause the vending machine 302 to behave as if the player had deposited $10 worth of cash into the cash-deposit slot 348, i.e., allowing the player to select $10 worth of additional pull-tab tickets 104 to be released via the dispenser 352.

In a second example of the “Select Prize Format” mode, the player's prize-format options include “all cash (110),” “all credits (120),” and “some cash (110) and some credits (120).” In this example, the vending machine 302 is again configured to temporarily re-purpose two of the existing “vending” buttons 350. For instance, the vending machine may re-purpose and illuminate the 2^{nd} button 350B and the 3^{rd} button 350C. In accordance with a set of written instructions output to the machine's display screen 374, the player can press the 2^{nd} button 350B to select “all cash (110),” press the 3^{rd} button 350C to select “all credits (120),” or simultaneously press both buttons 350B and 350C to select “some cash (110) and some credits (120).”

By selecting “all cash (110),” the vending machine's hard drive 362 commands the voucher printer 362 to generate and print out a paper voucher 370 bearing a scannable voucher code 372 to receive the full prize denomination in cash 110 from the prize-redemption device 108. By selecting “all credits (120),” the vending machine 302 internally generates a number of purchase credits 110 equivalent to the full prize denomination, and then reverts back to its default “Vending” mode, as described above. By selecting “some cash (110) and some credits (120),” the vending machine 302 reverts back to its default “Vending” mode, enabling the player to spend an initial portion of the prize denomination as purchase credits 120. At any point, the player can submit a predetermined user input (e.g., by long-pressing or holding down one of the vending buttons 350, or by simultaneously pressing two vending buttons 350), which causes the vending machine 302 to generate and print out a paper voucher 370 bearing a scannable voucher code 372 to receive the remaining portion of the prize denomination in cash 110 from the prize-redemption device 108.

In a third example of the “Select Prize Format” mode, the vending machine automatically behaves according to the “some cash (110) and some credits (120)” format option described in the previous example. That is, the vending machine 302 reverts back to its default “Vending” mode, enabling the player to spend an initial portion (including an initial portion of “zero”) of the prize denomination as purchase credit(s) 120. At any point, the player can submit a predetermined user input (e.g., by long-pressing or holding down one of the “vending” buttons 350, or by simultaneously pressing two buttons 350), which causes the vending machine 302 to generate and print out a paper voucher 370 bearing a scannable voucher code 372 to receive the remaining portion of the prize denomination in cash 110 from the prize-redemption device 108—up to and including the full amount, if no credits 120 were previously spent.

Notably, these first three examples of the “Select Prize Format” mode may be substantially implemented on an existing vending machine 302. That is, a ticket collector 358 and voucher printer 360 may be “retrofitted” to a vending machine 302 and enabled using the machine's existing input devices (i.e., vending buttons 350), thereby saving on materials and manufacturing costs.

In a fourth example of the “Select Prize Format” mode, the player's prize-format options include “all cash (110),” “all credits (120),” and “some cash (110) and some credits (120).” In this example, the vending machine 302 does not re-purpose any of the existing “vending” buttons 350A-350E. Instead, in this example (but not all examples), the vending machine 302 includes a designated “PRINT VOUCHER” button 376. That is, the vending machine 302 reverts back to its default “Vending” mode, enabling the player to spend an initial portion (including an initial portion of “zero”) of the prize denomination as purchase credits 120. At any point, the player can press the designated “PRINT VOUCHER” button 376, which causes the vending machine 302 to generate and print out a paper voucher 370 bearing a scannable voucher code 372 to receive the remaining portion of the prize denomination in cash 110 from the prize-redemption device 108—up to and including the full amount, if no credits 120 were previously spent.

In a fifth example of the “Select Prize Format” mode, the player's prize-format options include “all cash (110),” “all credits (120),” and “some cash (110) and some credits (120).” In this example, the vending machine 302 does not re-purpose any of the existing “vending” buttons 350A-350E. Instead, in this example (but not all examples), the vending machine 302 includes a multi-unit user input device 378, such as a(n alpha)numeric keypad, keyboard, or touchscreen. The input device 378 enables the player to indicate to the vending machine 302 a specific desired amount of cash (110) and/or credits (120). For instance, the player can use the input device 378 to indicate a specific dollar amount of cash 110 (with the remainder of the prize, if any, assigned to credits 120); a specific number of credits 120 (with the remainder of the prize, if any, assigned to cash 110); a specific ratio (e.g., “2:3”) of cash 110 to credits 120 or credits 120 to cash 110; or a split percentage split (e.g., “25%-75%”) of cash 110 and credits 120.

In the example of FIGS. 3A-3D, the ticket collector 358 and the voucher printer 360 are mounted to a lockable lower front door or panel 380 of the vending machine 302.

FIG. 5 is an oblique view of an example implementation (558) of the pull-tab-ticket collector-and-scanner 358 of FIGS. 3A-3D. Further enabling description and additional drawings of the ticket collector 558 may be found in this application's parent U.S. Utility patent application Ser. No. 19/074,050, as well as its counterpart U.S. Design Patent Application No. Ser. No. 29/992,419.

FIG. 6 is an oblique view of an example implementation (660) of the cash-voucher printer 360 of FIGS. 3A-3D. The voucher printer 660 can include any suitable paper-receipt printer, including a commercially available (or “aftermarket”) device, that is configured to be (or capable of being) communicatively paired with a prize-redemption device 108 according to an exclusive interactive “master/servant” type computing-device relationship. That is, the voucher printer 660 and the prize-redemption device 108 must include, at minimum, a shared proprietary software, firmware, and/or encryption layer such that the prize-redemption device 108 “obeys” certain commands from the voucher printer 660, but not from other computing devices. Specifically, the voucher printer 660 is configured to output a cash voucher 370 bearing a scannable code 372 that encodes both (1) a certain encryption key, and (2) a cash-prize denomination, such that the prize-redemption device 108, upon scanning the code 372, authenticates the “command” and then automatically dispenses a cash prize 110 corresponding to the encoded denomination. One non-limiting example of a suitable voucher printer 660 is the “PTI Phoenix Printer with Sentry Firmware for Redemption Kiosks” available from Pyramid Technologies, Inc. of Mesa, Arizona.

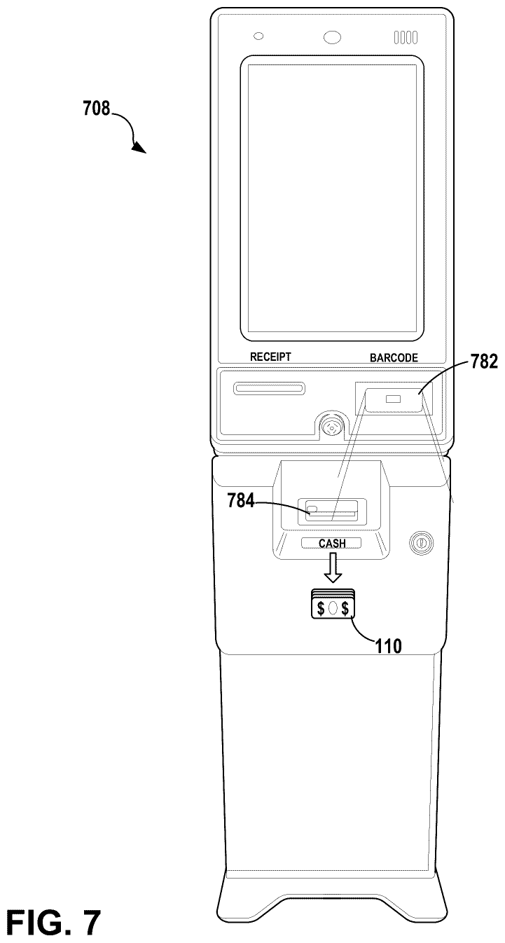

FIG. 7 shows a non-limiting example implementation of the prize-redemption device 108 of FIG. 1 in the form of a redemption kiosk 708. The kiosk 708 includes at least an optical scanner 782 configured to scan the scannable code 372 on the printed cash voucher 370, and a cash dispenser 784 configured to dispense the cash prize 110 associated with a prize-winning pull-tab ticket 106. Additional features, functionality, and configurations, and implementations of prize-redemption device 108 are shown and described in the related U.S. patent applications referenced above.

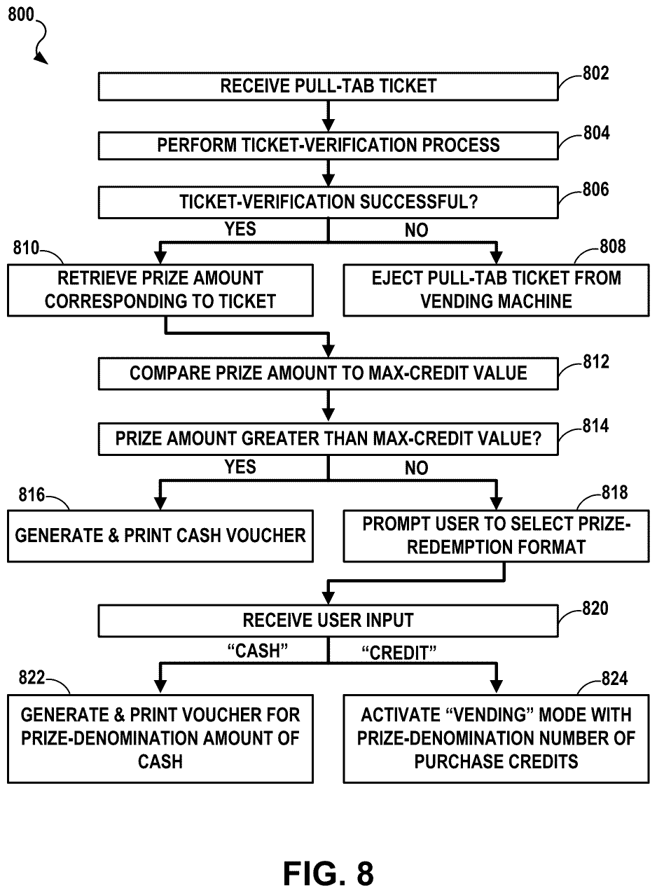

FIG. 8 is a flowchart of an example method of operation 800 of the pull-tab-ticket vending machine 102/302 of FIGS. 1, 3A-3D, and 4.

Via the proximal slot 364A of the integrated ticket collector 358, the vending machine 302 is configured to automatically intake a pull-tab ticket 104 (Step 802) that has been purchased and played (i.e., that has had its tabs 232 opened). In response to detecting an inserted pull-tab ticket 104, the ticket collector 358 scans the pull-tab ticket 206, attempting to detect a scannable prize-verification code 242B, such as a barcode or Quick-Response (QR) code, printed on the ticket (Step 804).

If the ticket collector 358 does not detect a scannable prize-verification code 242B printed on the pull-tab ticket 104 before the leading edge of the ticket 104 reaches the distal side of the ticket collector 358 (“NO” branch of Step 806), then the ticket collector 358 “rejects” the pull-tab ticket 104 by ejecting the ticket back out through the proximal slot 364A (Step 808). Similarly, if the ticket collector 358 detects a scannable code 242B on the pull-tab ticket 104, but the vending machine's hard drive 362 fails to verify the code 242 based on the game data 118 stored in memory (“NO” branch of Step 806), then the hard drive 362 transmits an “unverified” signal back to the ticket collector 358 that causes the ticket collector 358 to eject the pull-tab ticket 104 back out through the proximal slot 364A (Step 808).

Conversely, upon successfully detecting and scanning a scannable code 242B, the ticket collector 358 transmits the prize-verification code 242 to the primary hard drive 362 of the vending machine 302 (or another communicatively-coupled computing device) to verify the code 242, based on the set of game data 118 stored on the hard drive 362. In response to successfully validating the prize-verification code 242, thereby identifying the pull-tab ticket 104 as a prize-winning ticket 106 (“YES” branch of Step 806), the vending machine's hard drive 362 automatically executes a series of actions.

First, the hard drive 362 transmits a “verified” signal back to the ticket collector 358, causing the ticket collector 358 to further advance the pull-tab ticket 104 until the ticket is ejected outward through a distal slot 364B of the ticket collector 358. From there, the pull-tab ticket 104 falls into a secure receptacle 366 located fully within the external housing 368 of the vending machine 302, i.e., where the ticket 104 cannot be retrieved by the player.

Second, the vending-machine's hard drive 362 ascertains, based on the game data 118 stored in memory, a prize amount (or “prize denomination”) associated with the prize-winning ticket 106 (Step 810). In some examples, but not all examples, the hard drive 362 is configured to automatically compare the prize-denomination value to a predetermined maximum-credit value stored in memory (Step 812). The maximum-credit value represents a prize amount above which, for one or more reasons (e.g., laws and regulations, economic feasibility, contractual obligations), the player's prize must be awarded in the form of cash 110 dispensed by the prize-redemption device 108. Accordingly, if the retrieved prize-denomination value for the prize-winning ticket 106 is greater than the maximum-credit value (“YES” branch from Step 814), the vending machine's hard drive 362 automatically commands the cash-voucher printer 360 to generate and print out a paper voucher 370 bearing a scannable voucher code 372 to receive cash 110 from the prize-redemption device 108 (Step 816).

Conversely, if the retrieved prize-denomination value for the prize-winning ticket 106 is less-than-or-equal-to the maximum-credit value (“NO” branch from Step 814), then the vending machine's hard drive 362 thirdly activates a “Select Prize Format” mode of the vending machine 302, in which the vending machine 302 is configured to prompt the player for (Step 818), and to receive (Step 820), user input indicating the player's desired prize format: either cash 110 or purchase credits 120.

For instance, by selecting an “all cash (110)” option (“CASH” branch of Step 820), the vending machine's hard drive 362 commands the voucher printer 362 to generate and print out a paper voucher 370 bearing a scannable voucher code 372 to receive the full prize denomination in cash 110 from the prize-redemption device 108 (Step 822). Conversely, by selecting an “all credits (120)” (“CREDIT” branch of Step 820), the vending machine 302 internally generates a number of purchase credits 120 equivalent to the full prize denomination, and then reverts back to its default “Vending” mode (Step 824).

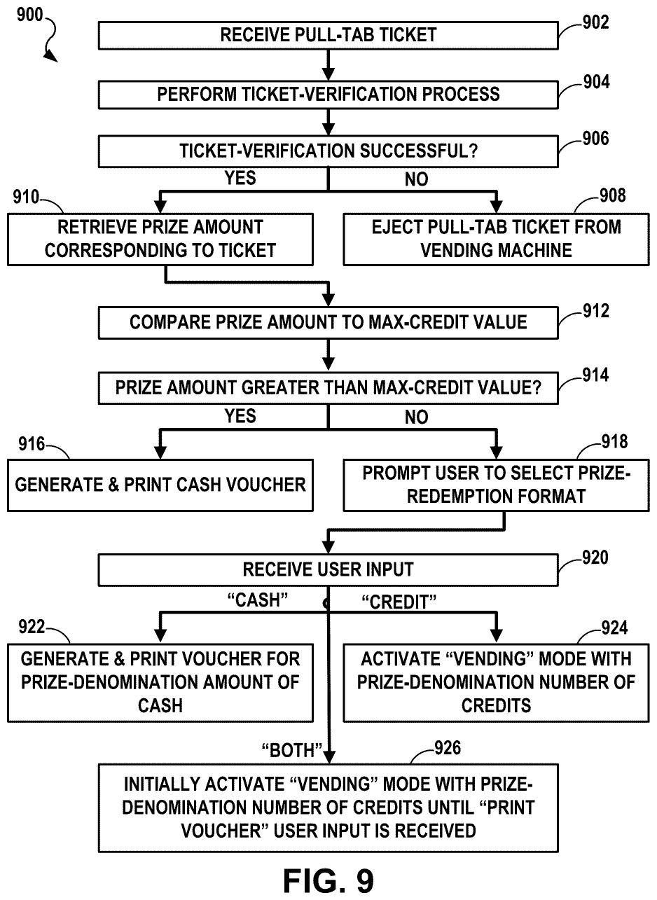

FIG. 9 is a flowchart of another example method of operation 900 of the pull-tab-ticket vending machine 102/302 of FIGS. 1, 3A-3D, and 4.

Via the proximal slot 364A of the integrated ticket collector 358, the vending machine 302 is configured to automatically intake a pull-tab ticket 104 (Step 902) that has been purchased and played (i.e., that has had its tabs 232 opened). In response to detecting an inserted pull-tab ticket 104, the ticket collector 358 scans the pull-tab ticket 206, attempting to detect a scannable prize-verification code 242B, such as a barcode or Quick-Response (QR) code, printed on the ticket (Step 904).

If the ticket collector 358 does not detect a scannable prize-verification code 242B printed on the pull-tab ticket 104 before the leading edge of the ticket 104 reaches the distal side of the ticket collector 358 (“NO” branch of Step 906), then the ticket collector 358 “rejects” the pull-tab ticket 104 by ejecting the ticket back out through the proximal slot 364A (Step 908). Similarly, if the ticket collector 358 detects a scannable code 242B on the pull-tab ticket 104, but the vending machine's hard drive 362 fails to verify the code 242 based on the game data 118 stored in memory (“NO” branch of Step 906), then the hard drive 362 transmits an “unverified” signal back to the ticket collector 358 that causes the ticket collector 358 to eject the pull-tab ticket 104 back out through the proximal slot 364A (Step 908).

Conversely, upon successfully detecting and scanning a scannable code 242B, the ticket collector 358 transmits the prize-verification code 242 to the primary hard drive 362 of the vending machine 302 (or another communicatively-coupled computing device) to verify the code 242, based on the set of game data 118 stored on the hard drive 362. In response to successfully validating the prize-verification code 242, thereby identifying the pull-tab ticket 104 as a prize-winning ticket 106 (“YES” branch of Step 906), the vending machine's hard drive 362 automatically executes a series of actions.

First, the hard drive 362 transmits a “verified” signal back to the ticket collector 358, causing the ticket collector 358 to further advance the pull-tab ticket 104 until the ticket is ejected outward through a distal slot 364B of the ticket collector 358. From there, the pull-tab ticket 104 falls into a secure receptacle 366 located fully within the external housing 368 of the vending machine 302, i.e., where the ticket 104 cannot be retrieved by the player.

Second, the vending-machine's hard drive 362 ascertains, based on the game data 118 stored in memory, a prize amount (or “prize denomination”) associated with the prize-winning ticket 106 (Step 910). In some examples, but not all examples, the hard drive 362 is configured to automatically compare the prize-denomination value to a predetermined maximum-credit value stored in memory (Step 912). If the retrieved prize-denomination value for the prize-winning ticket 106 is greater than the maximum-credit value (“YES” branch from Step 914), the vending machine's hard drive 362 automatically commands the cash-voucher printer 360 to generate and print out a paper voucher 370 bearing a scannable voucher code 372 to receive cash 110 from the prize-redemption device 108 (Step 916).

Conversely, if the retrieved prize-denomination value for the prize-winning ticket 106 is less-than-or-equal-to the maximum-credit value (“NO” branch from Step 914), then the vending machine's hard drive 362 thirdly activates a “Select Prize Format” mode of the vending machine 302, in which the vending machine 302 is configured to prompt the player for (Step 918), and to receive (Step 920), user input indicating the player's desired prize format: cash 110, purchase credits 120, or a combination of some cash 110 and some credits 120.

For instance, by selecting an “all cash (110)” option (“CASH” branch of Step 920), the vending machine's hard drive 362 commands the voucher printer 362 to generate and print out a paper voucher 370 bearing a scannable voucher code 372 to receive the full prize denomination in cash 110 from the prize-redemption device 108 (Step 922). Alternatively, by selecting an “all credits (120)” (“CREDIT” branch of Step 920), the vending machine 302 internally generates a number of purchase credits 120 equivalent to the full prize denomination, and then reverts back to its default “Vending” mode (Step 924).

Alternatively, by selecting a “some cash (110) and some credits (120)” option (“BOTH” branch of Step 920), the vending machine 302 may revert back to its default “Vending” mode, enabling the player to spend an initial portion of the prize denomination as purchase credits 120. At any point, the player can submit a predetermined user input (e.g., by long-pressing or holding down one of the vending buttons 350, or by simultaneously pressing two vending buttons 350, or by pressing a designated “PRINT VOUCHER” button 376), which causes the vending machine 302 to generate and print out a paper voucher 370 bearing a scannable voucher code 372 to receive the remaining portion of the prize denomination in cash 110 from the prize-redemption device 108 (Step 926).

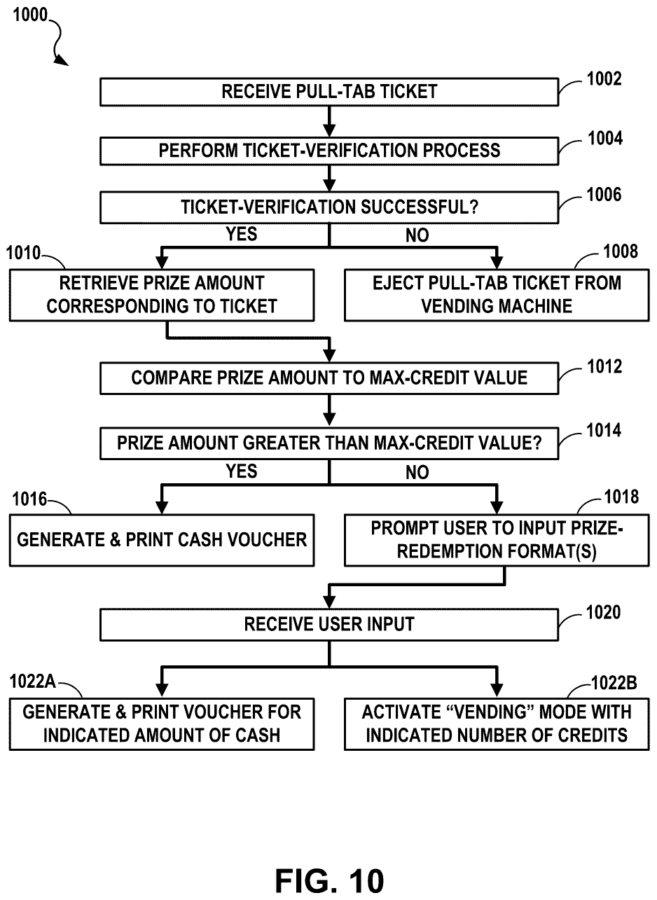

FIG. 10 is a flowchart of another example method of operation 1000 of the pull-tab-ticket vending machine 102/302 of FIGS. 1, 3A-3D, and 4.

Via the proximal slot 364A of the integrated ticket collector 358, the vending machine 302 is configured to automatically intake a pull-tab ticket 104 (Step 1002) that has been purchased and played (i.e., that has had its tabs 232 opened). In response to detecting an inserted pull-tab ticket 104, the ticket collector 358 scans the pull-tab ticket 206, attempting to detect a scannable prize-verification code 242B, such as a barcode or Quick-Response (QR) code, printed on the ticket (Step 1004).

If the ticket collector 358 does not detect a scannable prize-verification code 242B printed on the pull-tab ticket 104 before the leading edge of the ticket 104 reaches the distal side of the ticket collector 358 (“NO” branch of Step 1006), then the ticket collector 358 “rejects” the pull-tab ticket 104 by ejecting the ticket back out through the proximal slot 364A (Step 1008). Similarly, if the ticket collector 358 detects a scannable code 242B on the pull-tab ticket 104, but the vending machine's hard drive 362 fails to verify the code 242 based on the game data 118 stored in memory (“NO” branch of Step 1006), then the hard drive 362 transmits an “unverified” signal back to the ticket collector 358 that causes the ticket collector 358 to eject the pull-tab ticket 104 back out through the proximal slot 364A (Step 1008).

Conversely, upon successfully detecting and scanning a scannable code 242B, the ticket collector 358 transmits the prize-verification code 242 to the primary hard drive 362 of the vending machine 302 (or another communicatively-coupled computing device) to verify the code 242, based on the set of game data 118 stored on the hard drive 362. In response to successfully validating the prize-verification code 242, thereby identifying the pull-tab ticket 104 as a prize-winning ticket 106 (“YES” branch of Step 1006), the vending machine's hard drive 362 automatically executes a series of actions.

First, the hard drive 362 transmits a “verified” signal back to the ticket collector 358, causing the ticket collector 358 to further advance the pull-tab ticket 104 until the ticket is ejected outward through a distal slot 364B of the ticket collector 358. From there, the pull-tab ticket 104 falls into a secure receptacle 366 located fully within the external housing 368 of the vending machine 302, i.e., where the ticket 104 cannot be retrieved by the player.

Second, the vending-machine's hard drive 362 ascertains, based on the game data 118 stored in memory, a prize amount (or “prize denomination”) associated with the prize-winning ticket 106 (Step 1010). In some examples, but not all examples, the hard drive 362 is configured to automatically compare the prize-denomination value to a predetermined maximum-credit value stored in memory (Step 1012). If the retrieved prize-denomination value for the prize-winning ticket 106 is greater than the maximum-credit value (“YES” branch from Step 1014), the vending machine's hard drive 362 automatically commands the cash-voucher printer 360 to generate and print out a paper voucher 370 bearing a scannable voucher code 372 to receive cash 110 from the prize-redemption device 108 (Step 1016).

Conversely, if the retrieved prize-denomination value for the prize-winning ticket 106 is less-than-or-equal-to the maximum-credit value (“NO” branch from Step 1014), then the vending machine's hard drive 362 thirdly activates a “Select Prize Format” mode of the vending machine 302, in which the vending machine 302 is configured to prompt the player for (Step 1018), and to receive (Step 1020), via a multi-unit user-input device 378 (e.g., a(n alpha)numeric keypad, keyboard, or touchscreen), user input indicating the player's desired prize format(s): cash 110 and/or purchase credits 120.

For instance, the player can use the input device 378 to indicate a specific dollar amount of cash 110 (with the remainder of the prize, if any, assigned to credits 120); a specific number of credits 120 (with the remainder of the prize, if any, assigned to cash 110); a specific ratio (e.g., “2:3”) of cash 110 to credits 120 or credits 120 to cash 110; or a split percentage split (e.g., “25%-75%”) of cash 110 and credits 120. In response, the vending machine is configured to both: (1) generate and print a cash voucher 370 for the indicated amount of cash 110, if any (Step 1022A); and also (2) revert to the default “Vending” mode with the indicated number of purchase credits 120 posted, if any (Step 1022B).

It should be understood that individual steps of the previous examples may be performed in any suitable order and/or simultaneously, as long as the overall technique remains operable. Similarly, various aspects disclosed herein may be combined in different combinations than those explicitly presented in the description and accompanying drawings. Additionally, certain aspects of this disclosure described as being performed by a single module or unit (e.g., for clarity) may also be performed by a combination of units or modules associated with a pull-tab-gaming system 100 or pull-tab-ticket vending machine 102.

The techniques described herein may be implemented in hardware, software, firmware, or any suitable combination thereof. If implemented in software, the functions may be stored as instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital-signal processors (DSPs), general-purpose microprocessors, application-specific integrated circuits (ASICs), field-programmable logic arrays (FPGAs), or other equivalent integrated or discrete-logic circuitry. Accordingly, the term “processor” as used herein may refer to any of the foregoing structures or any other physical structure suitable for implementation of the described techniques, such as circuits or logic elements.

What is claimed is:

1. A pull-tab-ticket vending machine comprising:
a pull-tab-ticket collector-and-scanner;
a voucher printer communicatively paired with a prize-redemption device; and
processing circuitry communicatively coupled to both the pull-tab-ticket collector-and-scanner and the voucher printer, wherein the processing circuitry is configured to:
receive, from the pull-tab-ticket collector-and-scanner, a prize-verification code encoded by a first scannable code printed on a pull-tab ticket dispensed from the vending machine;
determine, based on a set of game data stored in a memory of the vending machine, that the pull-tab ticket is a prize-winning ticket and has not already been redeemed;
determine, based on the set of game data, a prize denomination associated with the prize-winning ticket;
in response to receiving a first user input, internally activate one or more credits for purchasing additional pull-tab tickets from the vending machine; and
in response to receiving a second user input, cause the voucher printer to print a paper voucher bearing a second scannable code that, when scanned by the prize-redemption device, causes the prize-redemption device to dispense a cash prize, wherein a collective value of the credits and the cash prize is equal to the prize denomination for the prize-winning ticket.

2. The vending machine of claim 1, wherein the processing circuitry is further configured to:
determine that the prize denomination is greater than a predetermined maximum-credit value stored in the memory of the vending machine; and
cause the voucher printer to print the paper voucher.

3. The vending machine of claim 1, wherein the processing circuitry is further configured to:
determine that the prize denomination is less than a predetermined maximum-credit value stored in the memory of the vending machine; and
cause the vending machine to prompt for the first user input and the second user input.

4. The vending machine of claim 3, further comprising a plurality of vending buttons, wherein causing the vending machine to prompt for the first user input and the second user input comprises:
re-purposing actuation of a first button of the plurality of vending buttons to indicate the first user input; and
re-purposing actuation of a second button of the plurality of vending buttons to indicate the second user input.

5. The vending machine of claim 3, further comprising a plurality of vending buttons, wherein the first user input comprises a single press of any of the plurality of vending buttons, and wherein the second user input comprises a long press or a double press of one of the plurality of vending buttons.

6. The vending machine of claim 3, further comprising a plurality of vending buttons and a “print voucher” button, wherein the first user input comprises a single press of any of the plurality of vending buttons, and wherein the second user input comprises a single press of the “print voucher” button.

7. The vending machine of claim 3, wherein the processing circuitry is further configured to:
receive a third user input indicating a desired cash-credit split; and
in response to receiving the third user input:
internally activate the one or more credits according to the indicated cash-credit split; and
cause the voucher printer to print the paper voucher according to the indicated cash-credit split.

8. The vending machine of claim 7, further comprising a numeric keypad or touchscreen configured to receive the third user input.

9. A method comprising:
receiving, by processing circuitry of a pull-tab-ticket vending machine from a pull-tab-ticket collector-and-scanner of the vending machine, a prize-verification code encoded by a first scannable code printed on a pull-tab ticket dispensed from the vending machine;
determining, by the processing circuitry based on a set of game data stored in a memory of the vending machine, that the pull-tab ticket is a prize-winning ticket and has not already been redeemed;
determining, by the processing circuitry based on the set of game data, a prize denomination associated with the prize-winning ticket;
in response to receiving a first user input, internally activating, by the processing circuitry, one or more credits for purchasing additional pull-tab tickets from the vending machine; and
in response to receiving a second user input, causing, by the processing circuitry, a voucher printer of the vending machine to print a paper voucher bearing a second scannable code that, when scanned by a prize-redemption device, causes the prize-redemption device to dispense a cash prize, wherein a collective value of the credits and the cash prize is equal to the prize denomination for the prize-winning ticket.

10. The method of claim 9, further comprising:
determining, by the processing circuitry, that the prize denomination is greater than a predetermined maximum-credit value stored in the memory of the vending machine; and
in response to determining that the prize denomination is greater than the maximum-credit value, causing, by the processing circuitry, the voucher printer to print the paper voucher.

11. The method of claim 9, further comprising:
determining, by the processing circuitry, that the prize denomination is less than a predetermined maximum-credit value stored in the memory of the vending machine; and
in response to determining that the prize denomination is less than the maximum-credit value, causing, by the processing circuitry, the vending machine to prompt for the first user input and the second user input.

12. The method of claim 11, wherein causing the vending machine to prompt for the first user input and the second user input comprises:
re-purposing, by the processing circuitry, actuation of a first button of a plurality of vending buttons of the vending machine to indicate the first user input; and
re-purposing, by the processing circuitry, actuation of a second button of the plurality of vending buttons to indicate the second user input.

13. The method of claim 11, wherein receiving the first user input comprises receiving a first signal indicative of a single press of any of a plurality of vending buttons of the vending machine, and wherein receiving the second user input comprises receiving a second signal indicative of a long press or a double press of one of the plurality of vending buttons.

14. The method of claim 11, wherein receiving the first user input comprises receiving a first signal indicative of a single press of any of a plurality of vending buttons of the vending machine, and wherein receiving the second user input comprises receiving a second signal indicative of a single press of a “print voucher” button of the vending machine.

15. The method of claim 11, wherein the processing circuitry is further configured to, in response to receiving a third user input indicating a desired cash-credit split:
internally activate the one or more credits according to the indicated cash-credit split; and
cause the voucher printer to print the paper voucher according to the indicated cash-credit split.

16. A non-transitory, computer-readable medium comprising instructions that, when executed by a processor of a pull-tab-ticket vending machine, cause the processor to:
receive, from a pull-tab-ticket collector-and-scanner of the vending machine, a prize-verification code encoded by a first scannable code printed on a pull-tab ticket dispensed from the vending machine;
determine, based on a set of game data stored in a memory of the vending machine, that the pull-tab ticket is a prize-winning ticket and has not already been redeemed;
determine, based on the set of game data, a prize denomination associated with the prize-winning ticket;
in response to receiving a first user input, internally activate one or more credits for purchasing additional pull-tab tickets from the vending machine; and
in response to receiving a second user input, cause a voucher printer of the vending machine to print a paper voucher bearing a second scannable code that, when scanned by a prize-redemption device, causes the prize-redemption device to dispense a cash prize, wherein a collective value of the credits and the cash prize is equal to the prize denomination for the prize-winning ticket.

17. The computer-readable medium of claim 16, wherein the instructions are further configured to cause the processor to:
determine that the prize denomination is less than a predetermined maximum-credit value stored in the memory of the vending machine; and
in response to determining that the prize denomination is less than the maximum-credit value, cause the vending machine to prompt for the first user input and the second user input.

18. The computer-readable medium of claim 17, wherein causing the vending machine to prompt for the first user input and the second user input comprises:
re-purposing actuation of a first button of a plurality of vending buttons of the vending machine to indicate the first user input; and
re-purposing actuation of a second button of the plurality of vending buttons to indicate the second user input.

19. The computer-readable medium of claim 17, wherein receiving the first user input comprises receiving a first signal indicative of a single press of any of a plurality of vending buttons of the vending machine, and wherein receiving the second user input comprises receiving a second signal indicative of a long press or a double press of one of the plurality of vending buttons.

20. The computer-readable medium of claim 17, wherein receiving the first user input comprises receiving a first signal indicative of a single press of any of a plurality of vending buttons of the vending machine, and wherein receiving the second user input comprises receiving a second signal indicative of a single press of a “print voucher” button of the vending machine.
